(19) United States
(12) Patent Application Publication
(10) Pub. No.: US 2024/0255081 A1
(43) Pub. Date: Aug. 1, 2024

(54) TANK RINSING DEVICE

(71) Applicant: B/E AEROSPACE, INC., Winston Salem, NC (US)

(72) Inventors: Piotr Jacek Kroczek, NIECISZÓW (PL); Dariusz Celestyn Sapija, KIELCZÓWEK (PL); Lukasz Turek, Wroclaw (PL)

(73) Assignee: B/E AEROSPACE, INC., Winston Salem, NC (US)

(21) Appl. No.: 18/418,254

(22) Filed: Jan. 20, 2024

(30) Foreign Application Priority Data
Jan. 26, 2023 (EP) 23461504.5

(51) Int. Cl. F16L 33/207; F16L 11/12; F16L 33/213

(52) U.S. Cl. CPC F16L 33/2073; F16L 11/12; F16L 33/213

(57) ABSTRACT

A rinse device comprising a housing part and a rinse hose, the housing part having a first end configured to be attached to a supply of pressurized fluid and a second end to which a first end of the rinse hose is attached, a second end of the hose is open to allow fluid to flow out of the hose, in use; the housing part defining a cavity through which pressurized fluid from the supply flows, in use, from the first end to the rinse hose, the rinse hose being a flexible and extendible hose provided with a plurality of openings through which the pressurized fluid is ejected; and wherein the rinse hose comprises an elongate tube through which the fluid flows, in use, the openings provided through the elongate tube.

### CROSS-REFERENCE TO RELATED APPLICATIONS

This application claims priority to, and the benefit of, EP Patent Application No. 23461504.5, filed Jan. 26, 2023 and titled “TANK RINSING DEVICE,” which is incorporated by reference herein in its entirety for all purposes.

### FIELD

The present disclosure relates to devices using for cleaning the interior of a tank such as, but not exclusively, a waste tank e.g. in an aircraft.

### BACKGROUND

Tanks or reservoirs containing matter such as waste from a sanitation system or other matter which may be contaminated or hazardous or generally undesirable if left on the inner surfaces of the tank for a period of time often include a device that extends into and sprays water or some cleaning fluid around the tank to clean the tank. This can avoid the need for manual cleaning of the tank which can be unpleasant or even dangerous. Furthermore, the tanks are often too small to enable a person to access the interior to clean it properly, or the tank may be vacuum sealed and so not accessible for manual cleaning and/or access to the tanks may be too difficult for the tank to be cleaned by a person. Passenger aircraft include large tanks for human waste from the aircraft toilets. These tanks are emptied after a flight and the inside of the tank is cleaned. This is usually done by means of a device, known as a rinse nipple, having nozzles through which pressurized water or a cleaning solution is sprayed around the interior of the tank.

A conventional rinse nipple includes a housing part to which a rinse hose providing the cleaning fluid is connected. The housing extends through the tank wall. A rinse head is provided at the end of the housing located inside the tank. The rinse head is provided with multiple openings or nozzles and the pressurized fluid is ejected out through the nozzles to clean the tank. Some rinse nipples have a rotatable rinse head. To avoid the need for power to be supplied to rotate the rinse head, the openings or nozzles are angled and offset relative to the axis of rotation of the head. This positioning provides momentum about the axis to cause the head to spin about the axis thus maximizing the coverage of the fluid inside the tank.

Whilst the multiple nozzles and spinning head ensures that the fluid is sprayed as much as possible around the tank interior, due to the presence of various components and fittings that may be provided on the tank walls, extending to the tank interior, there may be some areas that are effectively obstructed or hidden by these components and are not reached by the spray from the spinning head. Furthermore, particularly when the tanks are large. The fluid may not reach the bottom of the tank, or may not reach the bottom with sufficient force to provide effective cleaning. This can result in waste material or the like remaining in those areas where the pressurized fluid does not reach, and clogging or building up. The tank cannot, therefore, be fully purged of all of the waste, which can cause contamination of the tank.

There is, therefore, a need for a cleaning device that can ensure that a greater area of the tank interior is contacted by the spray of cleaning fluid.

### SUMMARY

According to the present disclosure, there is provided a rinse device comprising a housing part and a rinse hose, the housing part having a first end configured to be attached to a supply of pressurized fluid and a second end to which a first end of the rinse hose is attached, a second end of the hose is open to allow fluid to flow out of the hose, in use; the housing part defining a cavity through which pressurized fluid from the supply flows, in use, from the first end to the rinse hose, the rinse hose being a flexible and extendible hose provided with a plurality of openings through which the pressurized fluid is ejected; and wherein the rinse hose comprises an elongate tube through which the fluid flows, in use, the openings provided through the elongate tube, and wherein the elongate tube has a first, shrunk configuration in which the length of the tube is such that the second end of the hose it at a first distance from the housing, and a second, extended configuration in which the second end of the hose it at a second distance from the housing, the second distance being greater than the first distance, and wherein the tube is configured to extend from the first configuration to the second configuration in response to a predetermined pressure of fluid being present in the housing cavity.

In an example, the tube is elastic or resilient such that it returns to the first configuration in the absence of the predetermined pressure of fluid in the housing cavity.

In one example, the hose includes a flexible and extendible sleeve around the elongate tube, the openings provided through the tube and the sleeve, and the sleeve configured to extend as the tube extends, and, where the tube is elastic or resilient, to also return to its shrunk configuration as the tube returns to its first configuration.

In examples, the tube can be made of a material such as latex and the sleeve, where present, may be made of e.g. a polyester material. Other materials or combinations of materials may also be suitable.

A tank assembly and a cleaning method are also provided.

### BRIEF DESCRIPTION OF THE DRAWINGS

Examples of the rinse device according to this disclosure will be described with reference to the drawings. It should be noted that these are merely examples and variations are possible within the scope of the claims.

FIG. 1 shows an example of a known rinse device for the purposes of explanation;

FIG. 2 is shown to explain the problem of the known device such as shown in FIG. 1;

FIG. 3A shows, in cross-section, an example of a rinse device according to the disclosure in a first configuration;

FIG. 3B is a cross-sectional view of a rinse device according to the disclosure in a second, extended configuration;

FIG. 4 shows in close up a section of an example of the rinse device of the disclosure;

FIG. 5 illustrates in detail openings in a section of a device according to the disclosure;

FIG. 6A shows an example of the device of the disclosure in use, in a first configuration;

FIG. 6B shows an example of the device of the disclosure in use, in a second configuration;

FIG. 7A shows an example of a known rinse device in use, for comparison; and

FIG. 7B shows an example of a rinse device of the disclosure, in use, for comparison with FIG. 7A.

### DETAILED DESCRIPTION

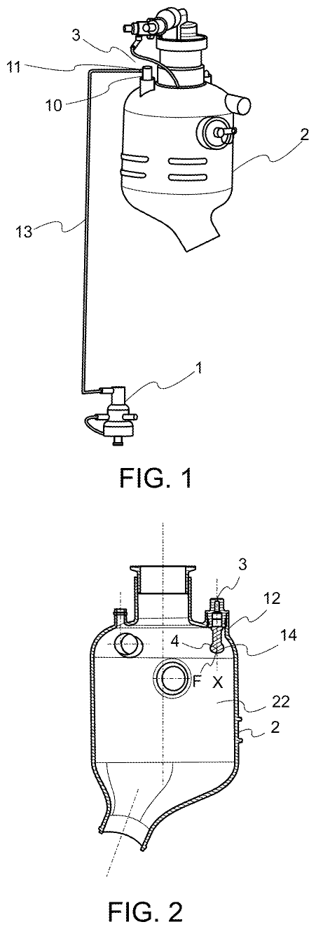

A typical rinse device is shown in FIGS. 1 and 2. A rinse nozzle 3 is shown mounted in the wall 12 of a tank 2 or vat or other reservoir. The rinse nozzle 3 is connected, in use, to a rinse port 1 from which rinse fluid is provided to the rinse nozzle from a rinse fluid supply (not shown). FIG. 2 shows, in cross-section, the rinse nozzle 3 mounted in the wall 12 of the tank 2, at the top of the tank. Apertures or jets 4 are formed in the nozzle 3 such that as rinse fluid is provided to the nozzle 3 it is sprayed out through the jets 4 around the interior 22 of the tank to clean the tank. A typical nozzle 3 comprises a housing 10, one end of which is provided with a fitting 11 arranged to be attached to a pipe or the like 13 via which pressurized water or cleaning solution is provided. At the other end of the housing through which the pressurized fluid flows, which extends into the tank, is mounted a rinse head 14 mounted to rotate relative to the housing 10. The rinse head is arranged to rotate about an axis of rotation X which is the axis through the housing from the one end to the other end.

The rinse head 14 is provided with a number of holes or jets 4 via which the pressurized fluid F forced through the housing is ejected into the tank. The jets can be positioned offset from the axis of rotation and at angles such that the ejection of the pressurized fluid F provides a force that causes the rinse head 14 to rotate relative to the housing about the axis X.

The pressurization of the fluid and the rotation of the rinse head provides a good range of coverage of the interior of the tank with cleaning fluid. In some cases, however, areas may exist, due to the presence of other components on the inside of the tank, that fluid from the rinse head cannot reach. Alternatively, because the rinse nozzle is typically small and mounted into the top of the tank, the pressurized fluid F may not adequately reach the bottom or other locations in the interior of the tank, or at least not with sufficient force to adequately clean the tank. Furthermore, as can be seen in FIG. 2, the jets do not clean the tank in a symmetrical manner.

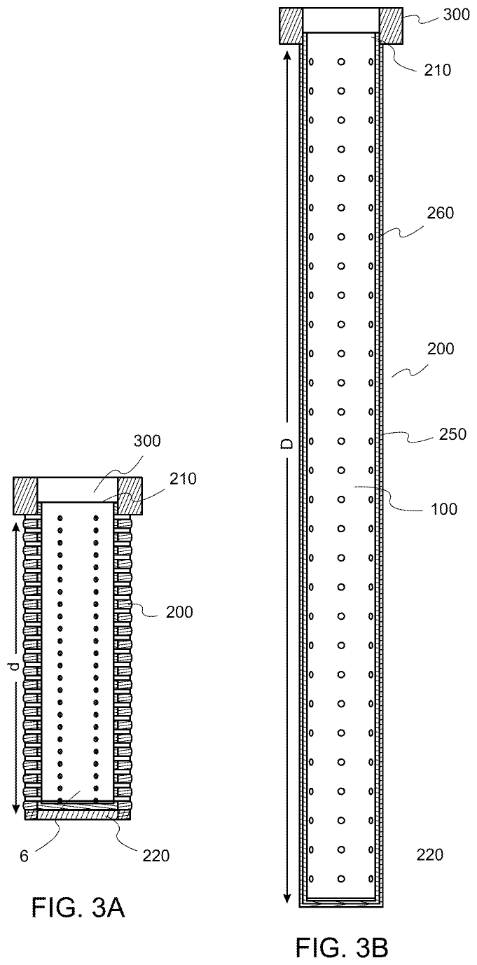

The rinse device according to this disclosure is designed to address these problems as will be described with reference to FIGS. 3 to 7.

With reference to FIG. 3, the rinse device of the disclosure is in the form of a longitudinally extendible hose 200 having a first end 210 configured to be attached to a housing 300 arranged to be mounted to the wall 12′ of the tank 2′ in a manner similar to the conventional housing described above and such that the hose 200 extends into the interior 22′ of the tank 2′. The housing 300 is also configured to be attached to a rinse fluid supply (not shown) like in the conventional rinse device described above. The second end 220 of the hose 200 is located inside the tank interior 22′. The hose 200 is made of stretchable or extendible material that stretches to extend the length of the hose 200 when rinse fluid is applied to the hose via the housing 300, this moving the second end 220 of the hose further away from the first end 210.

FIG. 3A shows the hose 200 in a first, shrunk configuration where the second end 220 of the hose is a first distance d from the first end of the hose 200—i.e. the hose 200 has a first length d. The hose is in this state when it is ‘unpressurized’ i.e. when no rinse fluid, or rinse fluid not exceeding a predetermined pressure, is applied to the hose via the housing. In this shrunk configuration, the hose 200 does not take up much space inside the tank.

FIG. 3B shows the hose in its second, extended configuration where the distance between the first and second ends of the hose—i.e. the length of the hose D is longer than the length d of the hose in the first configuration and so, in use, the hose extends further into the interior 22′ of the tank 2′. The hose takes this configuration when the rinse fluid applied to the hose via the housing 300 exceeds a predetermined pressure and the rinse fluid 100 fills the hose.

In an example, the hose is made of a resilient or elastic material such that it returns to its shrunk configuration when fluid pressure is removed or is less than the predetermined pressure.

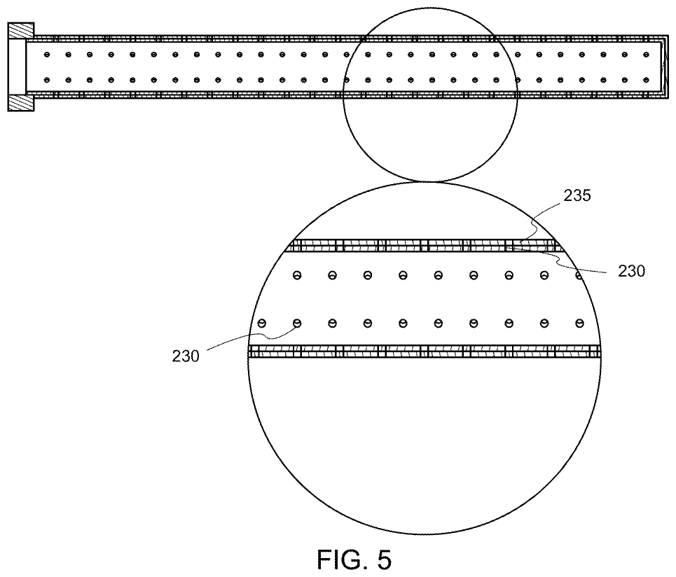

The hose is provided with a number of openings 230 best seen in FIG. 5 through which the rinse fluid 100 sprays out from the hose into the interior of the tank to clean the tank. The size, number and pattern of openings can be varied according to requirements. More and/or bigger openings will provide a greater rinse fluid flow which can reduce cleaning time. The diameter and length of the hose can also be selected according to requirements.

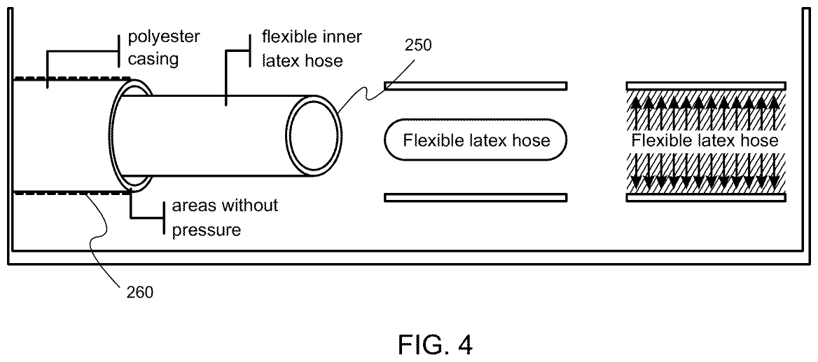

Whilst the hose 200 may be a single tube, in the example shown (and seen in detail in FIG. 4) the hose comprises an inner tube 250 and an outer sleeve 260 around the inner tube 250. Both the inner tube and the outer sleeve, in this case, would be configured to extend between the first and second configuration together. The outer sleeve provides protection for the inner tube and the design allows for some redundancy in the event that the inner tube or the outer sleeve is damaged.

The hose can be made of various known stretchable materials, for example, the hose may have an inner tube 250 of a material such as latex and an outer sleeve 260 of a material such as polyester. Of course, other materials/combinations of material can also be used.

As mentioned above, the rinse fluid is sprayed from the interior of the hose to the interior of the tank via openings 230 in the hose 230. These can be best seen in FIG. 5. In examples of the hose having an inner tube and an outer sleeve, the openings 230 should be aligned/coaxial at least in the stretched or extended configuration to ensure a clean direct spray of fluid through the hose openings. In one example, when the hose has an inner tube and an outer sleeve, the openings in one of the inner tube and the outer sleeve may be provided with a lip or step feature 235 to catch against the corresponding openings in the other of the outer sleeve and the inner tube. This lip or step feature 235 allows the openings in, say, the inner tube 250 to fix around the openings of the outer sleeve 260 (or vice versa) so that when the hose is extended, the holes are aligned in a coaxial manner. This feature also has the advantage that as the inner tube 250 extends to the second configuration due to the rinse fluid pressure in the hose, the engagement of the feature with the holes in the outer sleeve 260 draws the outer sleeve to expand along with the inner tube. This ensures that the inner tube and the outer sleeve expand in the same way as each other.

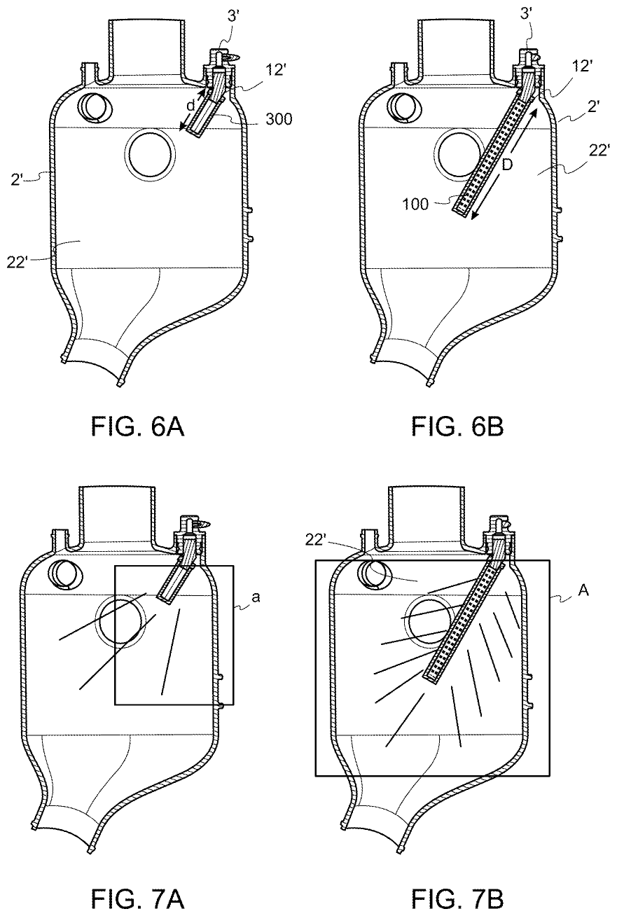

The cleaning operation using a rinse device according to the disclosure will now be described with reference to FIGS. 6A and 6B. FIG. 6A shows the device when not activated. The hose 300 is in its first, shrunk configuration extending distance d into the interior of the tank. No rinse fluid is being provided to the hose 300 at this time and so no rinse fluid is being sprayed into the tank 2′.

When rinse fluid from the supply (not shown) is provided to the housing 3′ of the rinse device it flows into the hose 300 and the pressure of the fluid inside the hose causes the hose to extend to its second configuration (length D). The rinse fluid 100 inside the hose 300 is sprayed out into the tank 2′ via the openings 230 in the hose provide force jets FF around the tank interior 22′ to clean the tank.

The rinse device of this disclosure provides improved coverage of the tank interior 22′ as can be seen by comparing the known device (FIG. 7A) and the device of the disclosure (FIG. 7B). It can be seen that the area of fluid coverage A of the new device is substantially greater than the area of coverage a of the known device. The new rinse device therefore has a greater effective cleaning area as the hose, in its extended configuration, extends further into the tank that the known rinse device. When not in use, however, the rinse device of this disclosure does not take up substantially more space that the known device.

Further, as the hose extends fully automatically when rinse fluid is switched on, there are no parts required to activate the system that would require additional maintenance.

1. A rinse device comprising a housing part and a rinse hose, the housing part having a first end configured to be attached to a supply of pressurized fluid and a second end to which a first end of the rinse hose is attached, a second end of the hose is open to allow fluid to flow out of the hose, in use; the housing part defining a cavity through which pressurized fluid from the supply flows, in use, from the first end to the rinse hose, the rinse hose being a flexible and extendible hose provided with a plurality of openings through which the pressurized fluid is ejected; and wherein the rinse hose comprises an elongate tube through which the fluid flows, in use, the openings provided through the elongate tube, and wherein the elongate tube has a first, shrunk configuration in which the length of the tube is such that the second end of the hose it at a first distance from the housing, and a second, extended configuration in which the second end of the hose it at a second distance from the housing, the second distance being greater than the first distance, and wherein the tube is configured to extend from the first configuration to the second configuration in response to a predetermined pressure of fluid being present in the housing cavity.

2. The rinse device as claimed in claim 1, wherein the elongate tube is elastic or resilient such that it returns to the first configuration in the absence of the predetermined pressure of fluid in the housing cavity.

3. The rinse device as claimed in claim 2, wherein the elongate tube is made of latex.

4. The rinse device as claimed in claim 1, wherein the rinse hose includes a flexible and extendible sleeve around the elongate tube, the openings provided through the tube and the sleeve, and the sleeve configured to extend as the tube extends, and, where the tube is elastic or resilient, to also return to its shrunk configuration as the tube returns to its first configuration.

5. The rinse device as claimed in claim 4, wherein the sleeve is made of a polyester material.

6. The rinse device as claimed in claim 4, wherein the openings comprises first openings provided through the elongate tube and second openings provided through the sleeve.

7. The rinse device as claimed in claim 6, wherein the first openings and the second openings are coaxial in the second configuration.

8. The rinse device as claimed in claim 7, wherein the first or the second openings are provided with a lip feature to engage with the other of the second and first openings.

9. The rinse device as claimed in claim 1, further comprising a seal between the housing part and the hose.

10. A tank having a tank wall defining a tank interior, and the rinse device as claimed in claim 1 mounted to the tank wall such that the second end of the rinse hose is located inside the tank interior.

11. The tank as claimed in claim 10, further comprising a port provided on the exterior of the tank and in fluid communication with the housing part, the port configured to be attached to a rinse fluid supply.

12. The tank as claimed in claim 10, being a waste tank for an aircraft.

13. A method of cleaning the tank as claimed in claim 10, the method comprising providing a rinse fluid to the hose via the housing part from a rinse fluid supply, the rinse fluid entering the hose and causing the hose to extend from the first configuration to the second configuration and causing the rinse fluid inside the hose to spray out from the hose into the interior of the tank.

14. The method of claim 13, further comprising switching off the supply of rinse fluid to the hose, causing the hose to return to the first configuration.
